(19) United States
(12) Patent Application Publication
(10) Pub. No.: US 2012/0286970 A1
(43) Pub. Date: Nov. 15, 2012

(54) VARIABLE TONE HORN SYSTEM

(75) Inventor: Brian V. Castillo, Birmingham, MI (US)

(73) Assignee: GM GLOBAL TECHNOLOGY OPERATIONS LLC, Detroit, MI (US)

(21) Appl. No.: 13/107,019

(22) Filed: May 13, 2011

(51) Int. Cl. G08G 1/16; G08G 1/00

(52) U.S. Cl. 340/903; 340/902

(57) ABSTRACT

A horn system for a vehicle is provided including a piezoelectric device, a loudspeaker, and a controller. The piezoelectric device is located in a horn pad of a steering wheel. The piezoelectric device produces a variable voltage due to varying pressure exerted on the horn pad. The piezoelectric device produces a first voltage signal and a second voltage signal. The first voltage signal is less than the second voltage signal. The loudspeaker is for emitting an audio signal. The controller is in communication with the piezoelectric device and the loudspeaker, and has a memory for storing at least a first audio file and a second audio file.

### FIELD OF THE INVENTION

Exemplary embodiments of the invention relate to a horn system for a vehicle and, more particularly, to a horn system that sends a varying audio signal to a loudspeaker due to varying pressure exerted on a horn pad.

### BACKGROUND

A typical car horn is an electromechanical device having a flexible metal diaphragm, an electromagnet, a switch, and a housing. Car horns are available in a variety of different sounds. The specific sound or frequency of the car horn is determined by the flexibility of the diaphragm, the power of the electromagnet, the mass of the diaphragm, the size and shape of the housing, and a number of other factors. When the horn button is pressed, the car horn creates a loud sound that may be in excess of 90 decibels.

Electromechanical horns usually only produce a single type of sound. That is, the car horn only produces one type of sound that is used for any kind of situation. The duration of the sound is variable, and is determined by how long the horn button is pressed. Therefore, a driver is able to adjust the duration of the car horn depending on the driving situation, but not the type of sound that the car horn produces. Because the car horn can only produce one type of sound, sometimes miscommunication may occur between drivers. For example, a driver may press the horn button for a short period of time to alert another driver that a traffic light has turned green. However, sometimes the horn button can be misinterpreted as aggression by the other driver, which potentially leads to road rage or an altercation. Accordingly, it is desirable to provide a car horn that provides clearer communication by providing a variety of different sounds.

### SUMMARY OF THE INVENTION

In one exemplary embodiment of the invention, a horn system for a vehicle is provided including a piezoelectric device, a loudspeaker, and a controller. The piezoelectric device is located in a horn pad of a steering wheel. The piezoelectric device produces a variable voltage due to varying pressure exerted on the horn pad. The piezoelectric device produces a first voltage signal and a second voltage signal. The first voltage signal is less than the second voltage signal. The loudspeaker is for emitting an audio signal. The controller is in communication with the piezoelectric device and the loudspeaker, and has a memory for storing at least a first audio file and a second audio file. The control module includes control logic for monitoring the piezoelectric device for one of the first voltage signal and the second voltage signal. The control module includes control logic for detecting one of the first voltage signal and the second voltage signal from the piezoelectric device. The control module includes control logic for converting the first voltage signal into a first digital signal and the second voltage signal into a second digital signal. The control module includes control logic for interpreting one of the first digital signal and the second digital signal. The control module includes control logic for signal for selecting one of a first audio file and a second audio file based on the first digital signal and the second digital signal. The first audio file corresponds to the first digital signal and the second audio file corresponds to the second digital signal. The control module includes control logic for converting one of the first audio file and the second audio file that is selected into the audio signal sent to the loudspeaker.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of an exemplary horn system in a vehicle; and

FIG. 2 is an illustration of a steering wheel of the horn system shown in FIG. 1.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality.

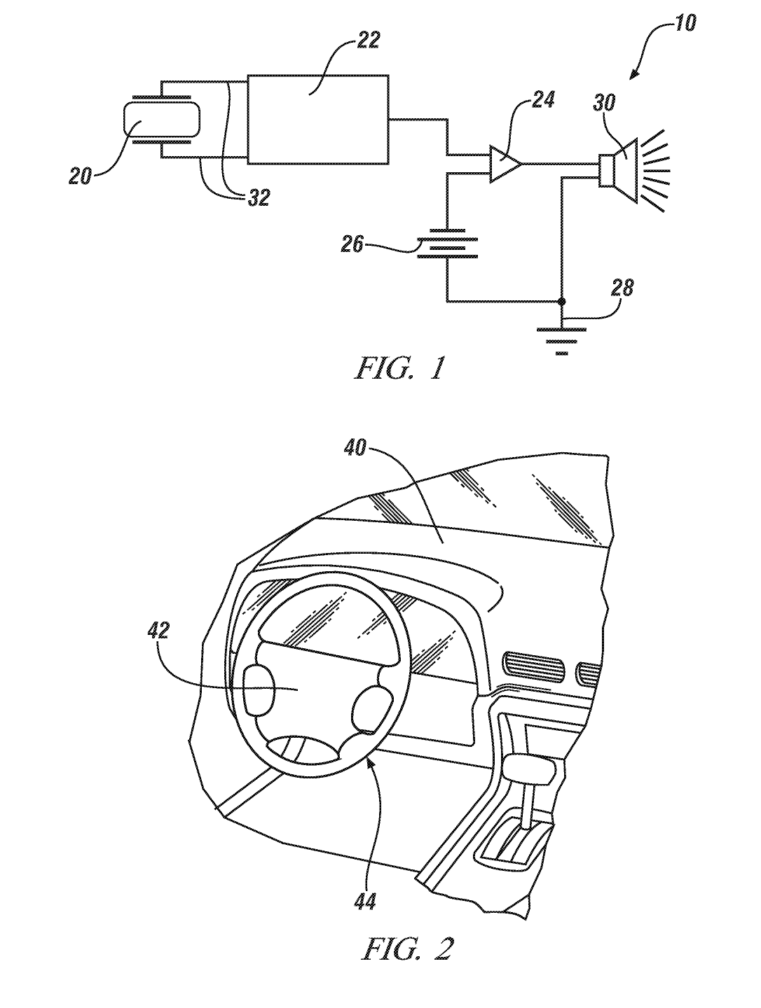

In accordance with an exemplary embodiment of the invention, a horn system 10 is illustrated schematically in FIG. 1. The horn system 10 includes a piezoelectric device 20, a controller 22, an amplifier 24, a battery 26, a chassis ground 28, and a car horn or loudspeaker 30. In the embodiment as shown, the horn system 10 is employed in a vehicle (not shown), and is used to emit a warning signal to other vehicles. The piezoelectric device 20 is constructed from a material that creates electrical voltage in response to mechanical forces, such as compression or expansion.

Turning now to FIG. 2, an exemplary vehicle dashboard 40 is shown. The piezoelectric device 20 (shown in FIG. 1) is located in a horn pad 42 of a steering wheel 44. The arrangement of the piezoelectric device 20 is dependent on the configuration of the steering wheel 44, the location of an airbag (not shown) located within the steering wheel 44, and size and geometry of the horn pad 42. During operation, a driver of the vehicle presses the horn pad 42 on the steering wheel 44. The pressing of the horn pad 42 deforms the horn pad 42 and compresses the piezoelectric device 20 (FIG. 1).

Referring back to FIG. 1, the piezoelectric device 20 reacts to the compression by creating a variable voltage (in the range of millivolts) based on pressure exerted on the horn pad 42. The value of the voltage created by piezoelectric device 20 varies based on the amount of pressure that is exerted on the piezoelectric device 20 as a driver presses the horn pad 42. Specifically, the piezoelectric device 20 creates different voltage values based on the amount of pressure exerted on the horn pad. In one embodiment, the value of the voltage ranges between about 0 mV for no pressure exerted on the horn pad 42 to about 100-200 mV for maximum pressure exerted on the horn pad 42. For example, in one embodiment, if the driver exerts a relatively low pressure onto the horn pad to alert another driver that a traffic light has turned green, the piezoelectric device 20 emits a relatively low voltage that is communicated to the controller 22. One example of a relatively low pressure is about 4.4 N, or about 1 lb. If the driver exerts a relatively moderate pressure onto the horn pad to alert another driver to watch out for a possible obstruction in the roadway, the piezoelectric device 20 emits a relatively moderate voltage that is communicated to the controller 22. If the driver exerts a relatively high pressure onto the horn pad to alert another driver of an impending crash, the piezoelectric device 20 emits a relatively high voltage that is communicated to the controller 22. It should be noted that while three varying voltage values are discussed, there may be more or less varying voltage values depending on driver usage as well. For example, in another embodiment there may be only a high and low varying voltage value instead.

The piezoelectric device 20 is connected to the controller 22 by a set of output leads 32. In the embodiment as shown in FIG. 1, only a single controller 22 is illustrated. However, it is understood that multiple controllers may be employed by the horn system 10. The controller 22 is also connected to the loudspeaker 30 through the amplifier 24. The controller 22 includes control logic for monitoring the piezoelectric device 20 for the variable voltage that is created by the piezoelectric device 20 when a driver presses the horn pad. Specifically, in one example the control module includes control logic for monitoring the piezoelectric device 20 for a first voltage value which corresponds to a relatively low voltage indicating that the driver is exerting a relatively low pressure onto the horn pad to alert another driver that a traffic light has turned green. The control module further includes control logic for monitoring the piezoelectric device 20 for a second voltage value which corresponds to a relatively moderate voltage indicating that the driver is exerting a relatively moderate pressure to alert another driver to watch out for a possible obstruction in the roadway. The control module further includes control logic for monitoring the piezoelectric device 20 for a third voltage value which corresponds to a relatively high voltage indicating that the driver is exerting a relatively high pressure to alert another driver of an impending crash.

The controller 22 includes a memory for storing audio files. In one embodiment, the memory of the controller 22 may be flash memory such as, for example, electrically erasable programmable read-only memory (EEPROM) that is erasable and programmable. In yet another embodiment, the memory of the controller 22 could be a hard drive. The audio files are horn tones that are sent to and played over the loudspeaker 30. Specifically the audio files are horn tones that correspond to specific driving situations or incidents. For example, a first audio file could correspond to a horn tone to alert another driver that a traffic light has turned green. A second audio file could correspond to a horn tone to alert another driver to watch out for a possible obstruction in the roadway. A third audio file could correspond to a horn tone to alert another driver of an impending crash. In one embodiment, the audio files could be customized depending on a user's preferences. For example, specific audio files could be downloaded from an Internet application by a user to be played over the loudspeaker 30. Specifically, the vehicle may be equipped with a telematics system such as, for example, OnStar® that facilitates downloading of the audio files off of the Internet.

The controller 22 includes control logic for converting the varying voltages received from the piezoelectric device 20 into digital signals. Specifically in one embodiment the controller 22 includes control logic for converting the first voltage value into a first digital signal, control logic for converting the second voltage value into a second digital signal, and control logic for converting the third voltage value into a third digital signal. The controller 22 further includes control logic for interpreting the specific digital signals and then selecting one of the audio files based on the digital signals. Specifically, in one embodiment, the controller 22 includes control logic for selecting the first audio file if the first digital signal is interpreted, selecting the second audio file if the second digital signal is interpreted, and the third audio file if the third digital signal is interpreted.

The controller 22 includes control logic for converting the audio file selected into an audio signal that is a horn tone sent to the loudspeaker 30. A digital to analog convertor may be used to convert the digital audio file into the audio signal, where the audio signal is an analog wave. In the embodiment as shown, the controller 22 is connected to the amplifier 24. The amplifier 24 is employed to amplify the audio signal produced by the controller 22. It should be noted that while a single controller 22 is illustrated, multiple controllers may be used as well. For example, in one embodiment, a first controller may be used including control logic to convert the voltage signal from the piezoelectric device 20 into a digital signal. A second controller may be in communication with the first controller to receive the digital signal from the first controller, and includes control logic for converting the digital signal into an audio signal that is played over the loudspeaker 30. In one embodiment, the second controller is a body control module, however it is understood that other types of vehicle control modules may be used as well.

The horn system 10 is employed to create different horn tones based on the amount of pressure that a driver exerts on the horn pad 42 of the steering wheel 44. For example, if the driver exerts a relatively low pressure onto the horn pad to alert another driver that a traffic light has turned green, the piezoelectric device 20 emits a relatively low voltage that results in the loudspeaker 30 playing a horn tone to alert another driver that a traffic light has turned green. Current electromechanical horns usually produce a single type of sound that is used for all types of situations. Because current car horns only produce one type of sound, sometimes miscommunication may occur between drivers. For example, a driver may press the horn button for a short period of time to alert another driver that a traffic light has turned green. However, sometimes the horn button can be misinterpreted as aggression by the other driver, which may lead to road rage or an altercation. In contrast, the horn system 10 produces different types of horn tones based on driver input.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A horn system for a vehicle, comprising:
a piezoelectric device located in a horn pad of a steering wheel, the piezoelectric device producing a variable voltage due to varying pressure exerted on the horn pad, the piezoelectric device producing a first voltage signal and a second voltage signal, the first voltage signal being less than the second voltage signal;
a loudspeaker for emitting an audio signal; and
a controller in communication with the piezoelectric device and the loudspeaker, the controller having a memory for storing at least a first audio file and a second audio file, the controller including:
a control logic for monitoring the piezoelectric device for one of the first voltage signal and the second voltage signal;
a control logic for detecting one of the first voltage signal and the second voltage signal from the piezoelectric device;
a control logic for converting the first voltage signal into a first digital signal and the second voltage signal into a second digital signal;
a control logic for interpreting one of the first digital signal and the second digital signal;
a control logic for selecting one of a first audio file and a second audio file based on the first digital signal and the second digital signal, the first audio file corresponding to the first digital signal and the second audio file corresponding to the second digital signal; and
a control logic for converting one of the first audio file and the second audio file that is selected into the audio signal sent to the loudspeaker.

2. The horn system of claim 1, wherein the first audio file is a horn tone that indicates a traffic light has turned green.

3. The horn system of claim 1, wherein the second audio file is a horn tone that indicates the presence of a possible obstruction in a roadway.

4. The horn system of claim 1, wherein the first audio file and the second audio file are downloadable audio files from an Internet application.

5. The horn system of claim 1, wherein the memory of the controller further includes a third audio file.

6. The horn system of claim 5, wherein the piezoelectric device produces a third voltage signal corresponding to a third pressure, the third voltage signal being greater than the first voltage signal and the second voltage signal.

7. The horn system of claim 5, wherein the third audio file is a horn tone that indicates an impending vehicle crash.

8. The horn system of claim 1, wherein the controller is connected to an amplifier that amplifies the audio signal produced by the controller.

9. The horn system of claim 1, wherein the controller is a body control module.

10. The horn system of claim 1, wherein the memory of the controller is one of flash memory and a hard drive.

11. A horn system for a vehicle, comprising:
a piezoelectric device located in a horn pad of a steering wheel, the piezoelectric device producing a variable voltage due to varying pressure exerted on the horn pad, the piezoelectric device producing a first voltage signal, a second voltage signal, and a third voltage signal, the first voltage signal being less than the second voltage signal, and the third voltage signal being greater than the first voltage signal and the second voltage signal;
a loudspeaker for emitting an audio signal; and
a controller in communication with the piezoelectric device and the loudspeaker, the controller having a memory for storing at least a first audio file, a second audio file, and a third audio file, the controller including:
a control logic for monitoring the piezoelectric device for one of the first voltage signal, the second voltage signal, and the third voltage signal;
a control logic for detecting one of the first voltage signal, the second voltage signal, and the third voltage signal from the piezoelectric device;
a control logic for converting the first voltage signal into a first digital signal, the second voltage signal into a second digital signal, and the third voltage signal into a third digital signal;
a control logic for interpreting one of the first digital signal, the second digital signal, and the third digital signal;
a control logic for selecting one of a first audio file, a second audio file and a third audio file based on the first digital signal, the second digital signal, and the third digital signal, the first audio file corresponding to the first digital signal, the second audio file corresponding to the second digital signal, and the third audio file corresponding to the third digital signal; and
a control logic for converting one of the first audio file, the second audio file, and the third audio file that is selected into the audio signal that is sent to the loudspeaker.

12. The horn system of claim 11, wherein the first audio file is a horn tone that indicates a traffic light has turned green.

13. The horn system of claim 11, wherein the second audio file is a horn tone that indicates the presence of a possible obstruction in a roadway.

14. The horn system of claim 11, wherein the third audio file is a horn tone that indicates an impending vehicle crash.

15. The horn system of claim 11, wherein the first audio file, the second audio file, and the third audio file are downloadable audio files from an Internet application.

16. The horn system of claim 11, wherein the controller is connected to an amplifier that amplifies the audio signal produced by the controller.

17. The horn system of claim 11, wherein the controller is a body control module.

18. The horn system of claim 11, wherein the memory of the controller is one of flash memory and a hard drive.

19. A horn system for a vehicle, comprising:
a piezoelectric device located in a horn pad of a steering wheel, the piezoelectric device producing a variable voltage due to varying pressure exerted on the horn pad, the piezoelectric device producing a first voltage signal, a second voltage signal, and a third voltage signal, the first voltage signal being less than the second voltage signal, and the third voltage signal being greater than the first voltage signal and the second voltage signal;
a loudspeaker for emitting an audio signal; and
a first controller in communication with the piezoelectric device, the first controller including:
a control logic for monitoring the piezoelectric device for one of the first voltage signal, the second voltage signal, and the third voltage signal;
a control logic for detecting one of the first voltage signal, the second voltage signal, and the third voltage signal from the piezoelectric device;
a control logic for converting the first voltage signal into a first digital signal, the second voltage signal into a second digital signal, and the third voltage signal into a third digital signal; and
a second controller connected to the first controller and the loudspeaker, the controller having a memory for storing at least a first audio file, a second audio file, and a third audio file, the controller including:
a control logic for monitoring the first controller for one of the first digital signal, the second digital signal, and the third digital signal;
a control logic for interpreting one of the first digital signal, the second digital signal, and the third digital signal;
a control logic for selecting one of a first audio file, a second audio file and a third audio file based on the first digital signal, the second digital signal, and the third digital signal, the first audio file corresponding to the first digital signal, the second audio file corresponding to the second digital signal, and the third audio file corresponding to the third digital signal; and
a control logic for converting one of the first audio file, the second audio file, and the third audio file that is selected into the audio signal that is sent to the loudspeaker.

20. The horn system of claim 19, wherein the first audio file is a horn tone that indicates a traffic light has turned green, the second audio file is a horn tone that indicates the presence of a possible obstruction in a roadway, and the third audio file is a horn tone that indicates an impending vehicle crash.
